(19) United States
(12) Patent Application Publication
(10) Pub. No.: US 2009/0100959 A1
(43) Pub. Date: Apr. 23, 2009

(54) Apparatus for actuating a motor vehicle pedal position sensor

(76) Inventors: Alexander Galea, Dingli (MT); Dawn Zammit, Tarxien (MT)

Correspondence Address: MILDE & HOFFBERG, LLP, 10 BANK STREET, SUITE 460, WHITE PLAINS, NY, 10606, US

(21) Appl. No.: 11/975,591

(22) Filed: Oct. 19, 2007

(51) Int. Cl. G05G 1/14

(52) U.S. Cl. 74/512

(57) ABSTRACT

The present invention relates to actuating device for at least one pedal (2) mounted for pivoting about an axis (3) in a pedal box (1) and including a position sensor (10) for detecting the position of pedal (2), said position sensor having an axle (10). Axle (10) of position sensor (9) is directly coupled to axis (3) for joint rotation therewith.

### BACKGROUND OF THE INVENTION

The present invention relates to apparatus for actuating a position sensor for the position of a pedal in a motor vehicle.

Actuating devices of the aforesaid kind have been known. For example, DE 43 31 909 A1 discloses an angle-of-rotation transducer specially suited for use as a pedal position transmitter. The said transmitter comprises a transmitter shaft coupled to rotating or pivoting means in a manner such as to be rotatable thereby in accordance with its rotated or pivoted position. The transmitter shaft is arranged to co-operate with a rotation angle sensor providing an electrical angle-of-rotation signal and comprising at least one linear position sensor coil which itself is stationary relative to the rotation of the transmitter shaft but has a coil core mounted for displacement therein. The coil core is mounted for displacement by the transmitter shaft via a crank assembly and the coil axis corresponding to core displacement in the position sensor coil is perpendicular to the axis of rotation of the transmitter shaft. The angle transmitter may be coupled to a pedal in a motor vehicle, for example, via said rotating or pivoting mechanism in a manner to angularly displace the transmitter shaft in accordance with pedal position.

A problem the above design causes is that rotating or pivoting mechanisms of the above kind are relatively complex in construction and prone to malfunction.

EP 0 401 288 B1 discloses a throttle pedal control device for an electronic drive control system in a motor vehicle in which a shaft is mounted for rotation in a housing, with a throttle pedal being mounted thereon to pivot between first and second positions against spring bias for rotary displacement of the shaft inside the housing. A position sensor is rotationally coupled with the shaft by pivoting means so as to generate an electric signal in accordance with pedal rotation from the first to the second position. The pivoting means includes a first paddle-shaped actuating member adapted to depress the actuating element of the position sensor in response to shaft rotation.

### SUMMARY OF THE INVENTION

It is the object of the present invention to improve on actuating means for a clutch and/or brake pedal in a motor vehicle so as to minimize its wear and proneness to malfunction.

This object, as well as further objects which will become apparent from the discussion that follows, are achieved, in accordance with the present invention, by mechanically coupling the position sensor directly to the pedal, for joint rotation therewith about the axis.

An essential advantage of the present invention is that it substantially reduces or minimizes wear and the susceptibility to malfunction of the inventive actuating device for a position sensor for clutch and/or brake pedal positions. Another advantage is that it obviates rotating or pivoting means or actuating members which are complex and susceptible to malfunction. As the position sensor is actuated directly, pedal path tolerances are reduced to a minimum. Advantageously, pedal positions can be displayed or identified directly at all times. Pedal movements are converted directly to a signal adapted to display predetermined switching positions or to derive a continuous signal. Noise generated between the clutch and/or brake pedal and the position sensor can be avoided. In accordance with the invention, continuous sensor pick-up can be implemented in a simple manner using contacting or non-contacting technology. Despite its very small size, the present actuating device is capable of detecting the full pedal path, including switching points near or at maximum pedal deflection. Conventional linear position sensors normally require relatively long paths of movement.

For a full understanding of the present invention, reference should now be made to the following detailed description of the preferred embodiments of the invention as illustrated in the accompanying drawings.

### BRIEF DESCRIPTION OF THE DRAWINGS

FIG. 1 shows a perspective view of a pedal box accommodating the inventive actuating device for a position sensor detecting the position of a pedal pivotally mounted inside the pedal housing.

FIG. 2 is an exploded view showing the constructional details of the inventive actuating device.

### DESCRIPTION OF THE PREFERRED EMBODIMENT

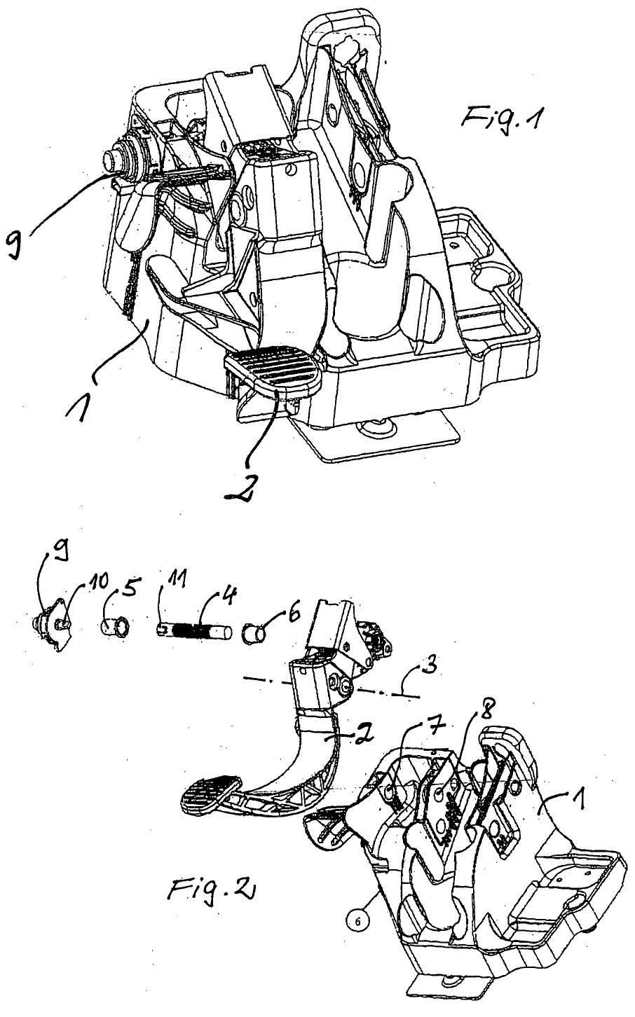

The preferred embodiments of the present invention will now be described with reference to FIGS. 1 and 2 of the drawings. Identical elements in the various figures are designated with the same reference numerals.

The considerations underlying the present invention are as follows. Conventional actuating devices for actuating a sensor used for detecting the position of a clutch and/or brake pedal disposed in a pedal box for pivotal movement about an axis of rotation are constructed in such a way that the pivoting movement of the pedal on a shaft is transmitted to the position sensor via rotary or pivoting means. This involves coupling the rotary shaft of the pedal to an actuating member adapted to rotate the axle or shaft of the position sensor or to move a plunger thereof in response to the pedal being actuated; usually this actuating member is relatively complex in construction, time-consuming to mount and prone to malfunction.

In accordance with the present invention, such proneness to malfunction, as well as wear, can be avoided by directly connecting the rotary shaft of the position sensor with the pedal shaft, whereby the use of an actuating member between the rotary shaft of the position sensor and the rotary shaft of the pedal is obviated and the attendant proneness to malfunction and wear is avoided.

As shown in FIGS. 1 and 2, a pedal box 1 has a pedal 2 mounted therein for rotation about an axis 3. Axis 3 is defined by a shaft 4 connected for rotation with pedal 2. Preferably, shaft 4 has one end mounted for rotation in a bearing 5 and its other end mounted for rotation in a bearing 6, with bearings 5 and 6 accommodated in a relatively low-friction manner by respective openings 7 and 8 in pedal box 1.

In accordance with the invention, the present actuating device has its position sensor 9 attached to pedal box 1 in such a manner that rotary axle 10 thereof is oriented to be coaxial with shaft 4 and is directly connected for joint rotation therewith, preferably through a pin-and-socket type connection. Preferably, such connection of axle 10 with shaft 4 is realized by providing on axle 10 a portion suitably shaped—to have a rectangular cross-sectional shape, for example—to be received by a mating opening 11 on the side of shaft 4 facing shaft 10. In this manner, the rotation of shaft 4 is transmitted directly to shaft 9; it also makes possible the attachment—by means such as threaded bolts, clips or the like—of position sensor 9 in an especially simple manner to an outside wall surface portion 12 of pedal box 1 as a separate element, with shaft 4 and/or rotary axle 10 extending through an opening (not shown) in wall portion 12.

There has thus been shown and described a novel apparatus for actuating a motor vehicle pedal position sensor which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. An actuating device for at least one pedal mounted for pivoting about an axis in a pedal box, including a position sensor having an axle and adapted to detect the position of pedal, the improvement wherein the axle of the position sensor is directly coupled to the pedal, for joint rotation about the axis.

2. Actuating device as in claim 1, wherein axis is formed by a shaft connected with pedal for rotation therewith and mounted for rotation in pedal box.

3. Actuating device as in claim 2, wherein axis of position sensor is formed to be coaxial with shaft and is mechanically connected therewith for joint rotation.

4. Actuating device as in claim 3, wherein the mutually associated end portions of axle and shaft being interconnected for joint rotation by means of a pin-and-socket connection.

5. Actuating device as in claim 4, wherein pin-and-socket connection being formed by the end portion of axle being profiled to be matingly received in a recess or opening in the end portion of shaft.

6. Actuating device as in claim 4, wherein the plug-and-socket connection being formed by the end portion shaft being profiled to be matingly received in a recess or opening in the end portion axle.

7. Actuating device as in claim 5, wherein said profile is shaped to differ from circular.

8. Actuating device as in claim 7, wherein the profile being polygonal, preferably triangular or rectangular, in cross-section.

9. Actuating device as in claim 1, wherein, when position sensor is secured to a wall portion of the pedal box, axle of sensor extends through an opening through said wall portion, with position sensor secured to the side facing away from pedal of said wall portion as a separate component.

10. Actuating device as in claim 9, wherein said side being an external side of the wall portion of pedal box.

11. Actuating device as in claim 1, wherein pedal being a clutch or brake pedal of a motor vehicle.

12. Actuating device as in claim 2, wherein shaft being mounted at both ends in bearings in pedal box.
